(19) United States
(12) Patent Application Publication
(10) Pub. No.: US 2006/0229941 A1
(43) Pub. Date: Oct. 12, 2006

(54) Method and apparatus for soliciting and serving banner advertisements based on time-dependent and situational-dependent events

(76) Inventor: Puneet K. Gupta, Newark, CA (US)

Correspondence Address: CENTRAL COAST PATENT AGENCY, PO BOX 187, AROMAS, CA, 95004, US

(21) Appl. No.: 11/400,003

(22) Filed: Apr. 7, 2006

Related U.S. Application Data
(60) Provisional application No. 60/670,421, filed on Apr. 11, 2005.

(51) Int. Cl. G06Q 30/00

(52) U.S. Cl. 705/14

(57) ABSTRACT

A system for placing advertisements in a user's display includes a portal through which the user communicates with content servers, an advertisement engine operating coupled to the portal, and a source of advertisements. The advertisement engine determines time and/or content-related information from the user's communication through the portal, selects advertisement from the source, and places the advertisements in display data directed to the user.

### CROSS REFERENCE TO RELATED DOCUMENTS

The instant application claims priority to U.S. provisional application Ser. No. 60/670,421 filed on Apr. 11, 2005. The application is incorporated herein in it's entirety at by reference.

### BACKGROUND OF THE INVENTION

1. Field of the Invention

The present invention is in the field of electronic advertising over data networks and pertains particularly to methods and apparatus for soliciting and serving banner type advertisements according to time and situational-dependant events.

2. Discussion of the State of the Art

In the field of electronic advertising using digital media over data packet networks, companies compete for valuable advertisement placement through third party hosted portals and Web sites. Arguably the most common form of network advertising is submission of and placement of banner advertisements, placement of which is solicited from companies by third-party hosts that deliver or place those advertisements into advertisement space reserved for the purpose in hypertext markup language (HTML), wireless markup language (WML), and other common electronic page formats. Banner advertisements are advertisements with which a user may interact to cause browser navigation to the URL or other network address specified in the banner code. Once at the advertisement host's domain, the user may further participate in the goal of the advertisement.

Banner ads are either statically placed on sites that host them, or are delivered dynamically to sites based on some competitive criteria that must be met by the advertisers to have their advertisements placed. One popular advertisement placement mechanism is insertion of ads dynamically into compiled Web pages as a result of content relevancy between the advertisement and the type of content in the compiled Web page. These are typically search engine result pages and the advertisements are matched for service to the keywords that resulted in the Web page content.

The content may be links to relevant Web pages and the advertisements delivered are considered sponsored advertisements sponsored by the company hosting the information search service. Physically speaking, the Web pages supporting these banner advertisements, or in many cases, text-based advertisements may be downloaded to personal computers, laptop computers, and more recently cellular telephones with Web browsing capabilities. Compensation for advertisement placement may be in the form of an amount for every click-through of an advertisement.

One problem with the advertisement venue described above is that the advertisements themselves are only content relevant and the degree of content relevancy can vary according to the skills of the individual associating the keywords to the advertisement for placement. Moreover, the target audience for those advertisements is not specifically defined, but rather loosely defined as individuals that might input advertisement-related keywords into a search engine submission dialog box. Many times the intent of the searcher is not well reflected in the specific keywords typed. Much skill is required to narrow search results by refining keyword queries.

Other venues of advertisement known to the inventor are radio spot advertisements or audio advertisements that may be placed in front of audio streams ordered by users over the network. Likewise, these advertisements are also content-relevant and the intent of the user receiving the advertisement may not be well defined.

The inventor knows of a system for integrating and managing academic and social activities from a single point of control. The system includes a central server connected to a wide-area-network; one or more distributed servers connected to the wide-area-network with the servers adapted for network-based academic learning and for communication with the central server over the network; one or more content servers connected to the wide-area-network, the content servers adapted to provide Web-based content and services and adapted for communication with the central server; and one or more instances of software distributed to network-capable computing devices, the software instances adapted for managing aspects of academic and social activities in conjunction with the main server for the operators of the computing devices.

In this system known to the inventor the subscriber base is, in a preferred embodiment, students that are actively taking college courses or some other form of education. Members of this subscriber base each have network-capable devices with which to engage in online management through the aid of a client application, of educational related activities and socially related activities. These two aspects are effectively merged for single-point control and management.

Advertisements relevant to the demographics of the subscriber base are, in some embodiments, placed statically or dynamically into Web pages maintained for individual ones of the subscriber base, which might be university students for example. Third-party advertisements placed are content relative in the example of a student body, to the types of products and services usually required. Therefore the advertisement placement is still only content relative. However, some advertisement placement into the subscriber audience of the system described above may be location sensitive to target a local university campus or a regional system of campuses or campus groups. So the advertisements placed in the venue described above for students may be both content relevant and location sensitive to the proximity of the educational environment of the subscriber base or a targeted portion thereof.

It has occurred to the inventor that in the above-described system, much additional information may be made available about individual ones of the subscribers to the system and of the educational systems that service those subscribers. One of these information sources is general calendar event information associated with the educational systems that the subscribers attend. Another of these information sources is the specific calendar information and schedule of each of the registered student or faculty subscribers. For example, a student's calendar may contain a class schedule, including pending task assignments, and the student's social calendar as well as the calendar of any student bodies a particular student is involved with, such as a fraternity or sorority. Likewise, the general calendar of the educational system may include scheduled social events, scheduled sporting events, and general academic flow applying to most or all students related to the general prevalent time periods. For example, the scheduled start of finals week, or mid terms, and the end dates when all assignments are due.

What is clearly needed is a system and methods for solicitation and placement of third-party advertisements into electronic advertisement venues wherein the advertisements are, in whole or part, configured according to time and date-sensitive triggers such as scheduled events, defined periods, and other known calendar-based criteria. A system such as this could leverage information to create highly valuable and timely advertisement space for banner advertisements, audio advertisements, or textual advertisements.

### SUMMARY OF THE INVENTION

In an embodiment of the invention a system for placing advertisements in a user's display is provided, comprising a portal through which the user communicates with content servers, an advertisement engine operating coupled to the portal, and a source of advertisements. The advertisement engine determines time and/or content-related information from the user's communication through the portal, selects advertisement from the source, and places the advertisements in display data directed to the user.

In one embodiment the portal provides services related to the user's academic life and/or social life. Also in one embodiment the engine mines data at servers to which the user connects for time sensitive or content-related data. Also in one embodiment the selection of advertisements includes negotiating with an advertisement placement facility for pricing and placement duration. In some embodiments the user communicates with a server at an educational organization, and the engine determines time-sensitive information or content-specific information from the server, the information related to activities associated with multiple users. In some cases the engine selects and places advertisements commonly to the multiple users based on the time-sensitive or content specific information determined.

In another aspect of the invention a method for placing advertisements in a user's display is provided, comprising steps of (a) determining time-sensitive or content-specific information associated with at least one user from a portal through which the user communicates with content servers; (b) selecting an advertisement from an advertisement source, the advertisement pertinent to the time-sensitive or content-specific information determined; and (c) causing the advertisement selected to be placed in a display directed to the user.

In one embodiment of the method the portal provides services related to the user's academic life and/or social life. Also in one embodiment the engine mines data at servers to which the user connects for time sensitive or content-related data. Also in one embodiment the selection of advertisements includes negotiating with an advertisement placement facility for pricing and placement duration.

In some embodiments the user communicates with a server at an educational organization, and the engine determines time-sensitive information or content-specific information from the server, the information related to activities associated with multiple users. In some embodiments the engine selects and places advertisements commonly to the multiple users based on the time-sensitive or content specific information determined.

### BRIEF DESCRIPTION OF THE DRAWING FIGURES

FIG. 1 is an architectural overview of a communications network wherein calendar-event-driven advertisement is practiced according to an embodiment of the present invention.

FIG. 2 is a block diagram illustrating dynamics of advertisement placement of third-party advertisements to a subscriber base based on calendar-driven events according to an embodiment of the present invention.

FIG. 3 is a block diagram illustrating dynamics of subscriber-sourced advertisement placement to other subscribers interfaces based on calendar-driven events according to another embodiment of the present invention.

### DETAILED DESCRIPTION OF EMBODIMENTS OF THE INVENTION

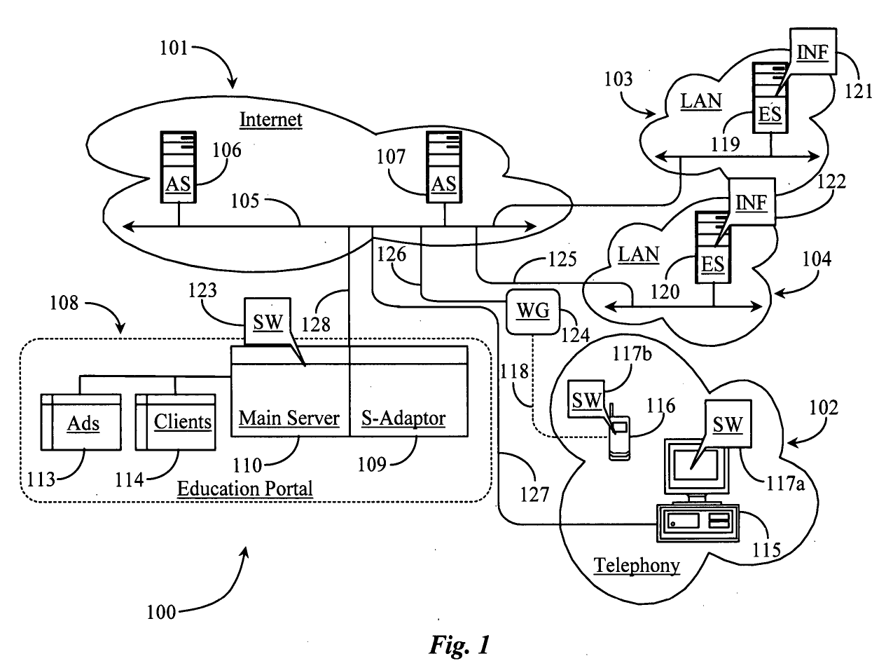

FIG. 1 is an architectural overview of a communications network 100 wherein calendar-event driven advertisement is practiced according to an embodiment of the present invention. Communications network 100 includes a wide-area-network (WAN) 101, which in one embodiment is the well-known Internet network. Network 101 will hereinafter be referred to as Internet 101. Internet 101 has an Internet backbone 105 extending throughout that represents all of the lines, equipment and access points that make up the Internet as a whole. Therefore there are no geographic limitations to the practice of the present invention.

Communications network 100 also includes a telephony network 102. Telephony network 102 may be a public-switched-telephone-network (PSTN), or another type of telephone network including a wireless telephone network without departing from the spirit and scope of the present invention. Telephony network 102 typically includes telephone switches, routers, gateways, and carrier equipment well known in the art and therefore not illustrated in detail in this example. In one embodiment, telephone network 102 is a wireless telephone network.

A user 115, represented herein as a computer icon is illustrated within telephony network 102. User 115, in this example, has connection to Internet 101, more specifically to backbone 105 by way of Internet access line 127. Internet connectivity for user 115 may be a dial-up connection through an ISP, a cable/modem connection, or a digital subscriber line (DSL) connection, or any other sort of network access connection. Likewise, in an embodiment of a wireless network 102, user 115 may connect to Internet 101 through a wireless carrier. There are many possible connection architectures known in the art. A cellular user 116 is illustrated within telephony network 102 in a wireless connection embodiment. User 116 is represented herein as a cellular telephone that is capable of Internet navigation in wireless mode. User 116 has a wireless connection 118 to a wireless gateway (WG) 124. WG 124 has connection to backbone 105 by way of an Internet access line 126.

Communication network 100 also includes an education portal service 108, which in a preferred embodiment is adapted to provide organization and management services to education clients such as university students and faculty, for example. Portal service 108 is known to the inventor and provides, more particularly, organizational and management capabilities to clients for managing their on-line and off-line academic lives and their on-line and off-line social lives through a single point of control. Portal 108 in one embodiment has a main server 110 adapted to serve personalized Web pages to registered clients and to handle service billing and registration tasks. Server 110 has connection to backbone 105 by way of an Internet access line 128. A client database 114 is illustrated within the domain portal service 108 and may be accessed directly from main server 110. Database 114 contains reserved space for each registered client, the space adapted to contain all of that client's academic information, contact information, billing information, subscription information, and other information a client may add to the space.

Main server 10 has a server adaptor 109 associated therewith. Adaptor 109 is enabled, in this embodiment, to communicate with and to exchange information with education servers that are associated with traditional university education systems or other network-accessible education systems. Many of these existing education systems and services use proprietary software and access methods. Adaptor 109 has all of the components necessary to enable successful communication with and proxy emulation of those proprietary systems that otherwise would be directly accessed by local students registered to those systems. There are two such educational systems illustrated in this example and supported by sub networks 103 and 104 respectively. Network 103 is, in this example, a local area network (LAN) supporting at least one education server ES 119. LAN 103 may be a single university LAN or several LANs connected together and extending through part of a university campus. LAN 104 supports ES 120 and forms a system similar to the description of LAN 103. LANs 103 and 104 are separate and unconnected networks of completely different educational systems or organizations in this example. However, they may be connected sub networks of a single education network without departing from the spirit and scope of the present invention.

LAN 103 has Internet connectivity to backbone 105 through an Internet access line 129. LAN 104 has Internet connectivity to backbone 105 through an Internet access line 125. Both educational systems represented by LAN 103 and LAN 104 respectively may advertise themselves as on-line education systems and may include server/client applications designed to enable student access to services through Internet 101. Therefore for the purpose of this specification, ES 119 on LAN 103 and ES 120 on LAN 104 are considered to be Internet-accessible servers that may be accessed by clients of those servers or by remote systems communicating with them.

In practice, user 115 may be a client of ES 119 on LAN 103. Portal 108 has access to ES 119 and may represent the client by proxy and may interact with the server as though it were the client. The same is possible with respect to ES 120 on LAN 104. The user has an instance of client software 117a installed and user 116 has an instance of client software 117b installed. Software 117a and software 117b are client applications that may be standalone applications including browser capabilities. The instances are client graphic user interface (GUI) applications that enable users to manage and organize their academic and personal activities in an offline mode. When online, users may synchronize data between their respective devices and their personal spaces in client database 114. The differences in SW 117a and SW 117b simply reflect the differences in device type for which an instance is designed. SW 117a is designed for a desktop or laptop-computing device while SW 117b is designed for a wireless telephone with network browsing capability.

Users 115 and 116 login to main server 110, for example, to download new class registration information and class schedules. Other information available from systems 119 and 120 is also available for synchronization. ES 119 has an information (INF) block 121 illustrated thereon that represents any information pertinent to a user that may be available to that user of ES 119. For example, INF 121 includes any user data for classes, book requirements, schedules, testing dates, and the like. INF 121 may also contain general education calendar information, scheduled events, sporting event schedules, student break periods, activity schedules, and the like. ES 120 has an information (INF) block 122 illustrated thereon, which is analogous in description to INF 122 of server 119. Main server 110 aided by SW 123 has access to all of the general ES information and all of the student-relevant ES information. Therefore, any user registered with portal 108 may see all of his or her relevant information and any general information by logging into main server 110 and authenticating with the server.

Portal 108 may provide advertisement placement services to third-party advertisers. Internet 101 in this example includes a first advertisement server (AS) 106 and a second advertisement server (AS) 107. AS 106 and AS 107 may be adapted to contain and serve banner advertisements or text-based advertisements designed by various and sundry companies. In one embodiment, advertisements served by AS 106 and AS 107 may be stored for service in an advertisement database 113 maintained within the domain of portal server 108, in this example connected to main server 110. Main server 110 aided by SW 123 may select advertisements from database 113 for service into user interface data maintained in clients database 114 such that the next time user 115 logs into server 110, those advertisements may be inserted into advertisement space reserved for the purpose, whereupon those advertisements are viewable within user GUI SW instance 117a. The same advertisements, or a lighter version of them, may be served in a fashion as to be compatible also with device 116 running GUI 1117b.

In a preferred embodiment advertisements are served based on calendar-driven triggers created with information received at server 110 from ES 119 and ES 120. Likewise, calendar-based data entered and maintained by individual users may also be leveraged by portal service 108 to provide target advertisement placement services for both third-party advertisers and student advertisers targeting other students. SW 123 has an advertisement engine (not illustrated) in this embodiment that intercepts calendar-based data and analyzes that data for content relevancy and for time sensitivity in marketing.

Time sensitivity in marketing refers to the time period before a scheduled event, function, or period of definable activity that is critical for an advertisement to be introduced into advertisement space reserved for the purpose. Likewise, time sensitivity for advertising may include the time period during a scheduled period of definable activity or over a prolonged event, which may be content relevant to a particular advertisement. One simple example might be a Starbucks™ advertisement for discount coffee drinks that may be placed during a period defined as a student testing week, logically accompanied by nights of intense studying. During the testing period, it is likely that students, for example, might purchase coffee to stay awake more often then at other times during the week. Therefore, advertisement space reserved for the period is logically more valuable than the same advertisement space during other periods.

Third-party advertisers may compete for time-sensitive advertisement space reserved for banner advertisements or text-based advertisements. The advertisement space may be provided on any number of HTML, WML, or other formatted Web pages that are delivered to user devices like devices 115 and 116. In addition to content relevancy, calendar-event-driven advertising greatly increases the likelihood that the advertising audience will cooperate with the goal of the placed advertisements. Likewise, in an embodiment where subscribers advertise to other subscribers, calendar-event-driven advertisement placement provides targeting capability of locating those individual subscribers who are in need (at the time) of the subject matter of the advertisement.

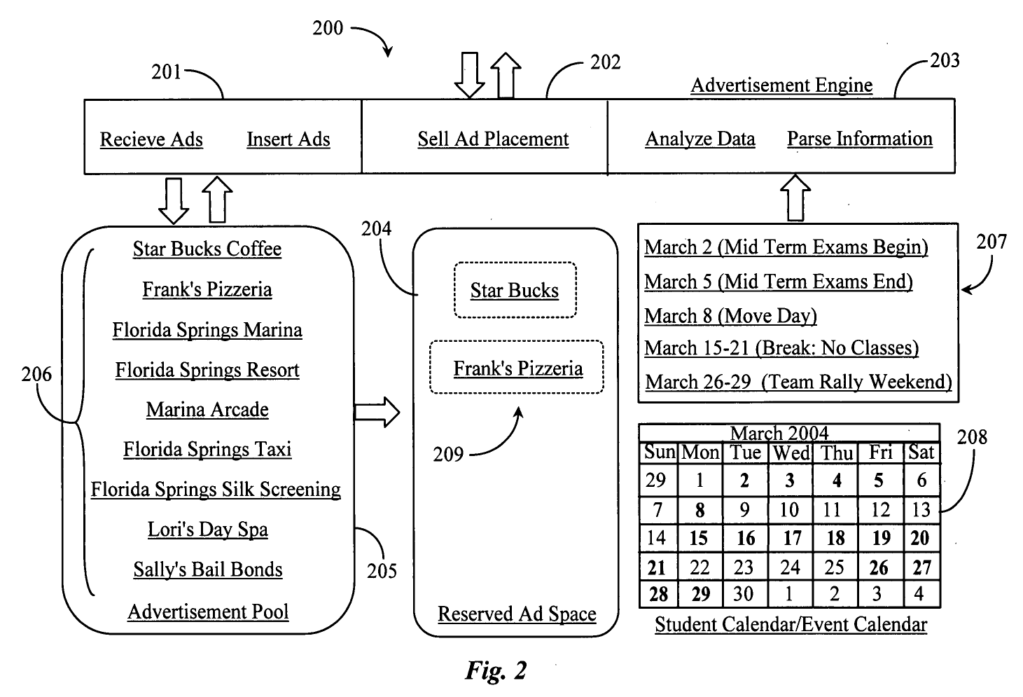

FIG. 2 is a block-diagram illustrating dynamics of advertisement placement of third-party advertisements to a subscriber base based on calendar-driven events according to an embodiment of the present invention. One of the relevant pieces of information that may be used to determine time-sensitive advertising space is information that may be gleaned from an online-interactive calendar maintained, as described in one embodiment, by a student attending an educational system. The calendar may contain both student-entered data and university provided data. An interactive calendar face 208 is illustrated in this example for the month of March. Calendar face 208 may be a student calendar or a university event calendar. In the first case, it is likely that both generic events common to many students and personal scheduled events would be recorded. In the latter case, it is likely that many of the important university events, happenings, and scholastic schedule of events would be available at least one Month or more in advance of such events.

In an interactive calendar application date entries may be associated with rich data information describing those events, the event times, the event locations, and other like information. In this particular case, calendar 208 contains general events that may affect a number of students at the university at a same period of time enabling definition of group audiences for targeting for advertisement placement. Calendar face 208 exhibits several days in bold type that are days occupying scheduled events. An event description block 207 is illustrated in this example and contains the data associated with the bolded calendar days. For example, on March 2, midterm exams begin and on March 5 those exams end. Therefore, immediately before and during the period of March 2-March 5, time sensitive advertisement space exists. This is a university schedule, so it may affect a large number of students at the university, many of which may be subscribers to portal services described further above.

An advertisement space 204 is illustrated in this example and logically represents any available advertisement space that may be utilized for advertisement placement. Any rendered or compiled Web page that may be served to a student device may have some advertisement spaced reserved for placement. Likewise pop-up advertisement windows may also be used without departing from the spirit and scope of the present invention. Advertisements 209 are illustrated within space 204 and represent advertisements occupying the space for the period immediately before and during mid term exams. An advertisement pool 205 is illustrated in this example and may be analogous to advertisement database 113 of FIG. 1 above, or it may be a separate advertisement pool adapted for the purpose of containing relevant advertisements for pending service.

Advertisements 206 are stored, in one embodiment, in advertisement pool 205. In this example, advertisements 206 include advertisements for Starbuck's coffee, and for Frank's Pizzeria. These advertisements are illustrated in this example as served into space 204 as advertisements 209. Logically speaking, these advertisements contain more content relevancy to mid term exams than the other listed advertisements 206. Therefore, immediately before and during the time period of March 2-5, these advertisements are served into the reserved advertisement space for all of the affected subscribers.

An advertisement engine 200 is provided in a preferred embodiment of the present invention, and may be considered part of server-side software 123 described with reference to FIG. 1 above. Engine 200 may search out and intercept calendar-based information and other information that is schedule-based or otherwise may be associated with a certain period of time. Engine 200 contains a portion 203 thereof, which is adapted to parse out time-sensitive or calendar-based data from subscriber data and from educational server data that it may intercept, or in some cases for which it may proactively search. Once data is parsed out, it is analyzed for utility according to a set of rules. Utility may relate to the likelihood that an event may include enough of a subscriber base to entice third-party advertisers to compete for related advertisement space.

Engine 200 has an advertisement placement engine, which is adapted to provide third-party advertisers with all of the information required to bid for or to otherwise purchase advertisement space for certain defined periods. The information may include the period for which advertisements will be run, the subject matter of the event for the period, and the pricing information related to placement. The placement engine works according to a time schedule ahead of any impending event for which it sells advertisement placement services. For example, selling for advertisement space related to the period of March 2-5 may begin perhaps a week or so before the period arrives, to give advertisers time to bid for and receive placement services and in some cases time to design promotions or special discounts to run just for the intended period.

Engine 200 includes an advertisement insertion module 201 adapted to receive relevant advertisements from advertising entities and to insert those advertisements into student interfaces according to the specified life of those advertisements. In one embodiment, the advertisements are pre-inserted into client database 114 into subscriber spaces affected by an advertising campaign whereupon those ads are picked up and inserted into the HTML or other formatted interfaces along with other pertinent data when those students log in during the life of those advertisements to organize and manage their data. In another embodiment, third-party advertisement servers like servers 106 and 107 described with reference to FIG. 1 above may be authorized to server approved advertisements directly into user interfaces when they are logged into the portal service. In this embodiment, portal service 108 may provide temporary invisible advertisement-reference hyperlinks within the user interfaces that when activated forge links to servers 107 or 108 that request service of the advertisements as is typically known in HTML-based advertisement placement.

The next significant event on calendar 208 is a defined period between March 15 and March 21. Information block 207 defines the period as a spring break with no classes. This event affects all of the students subscribing to the portal system. Therefore, the next runs of advertisements are those that are content-relevant to services a student might use during a spring break. Geographically speaking, advertisers competing for advertisement space during a spring break may be those local to the area where many of the students are known to congregate during the event though the area of congregation may be remote from the physical location of the university system.

In the above example, competing advertisements approved for service include a marina, a resort, an arcade, and a taxi company all from an area local to the point of anticipated congregation of those subscribers. Likewise, advertisement engine 200 may begin selling advertisement space to certain advertisers long before the anticipated event so that the advertisements may begin running the first two weeks of March, for example, to give ample time to make reservations and so on. Those advertisements may continue running in some embodiments throughout the break period itself as well to pick up last minute customers. In the case of taxi services, the space may be limited to actual event-period placement because it involves real-time patrons.

The next significant event for March is a team rally weekend schedule for March 26 through March 29. The team rally weekend may include a final game for the regional championship for example. Advertisers that may provide content relevant services or products over the team rally period include a day spa, a silk screening shop (t-shirts), and a local bail bondsman anticipating some student arrests. The taxi service may also be relevant if it is local to the area of the activities.

The only event on calendar 208 that might be considered insignificant for third-party advertising is March 8^{th} defined as move day in block 207. This entry might be a personal user entry scheduling a move from one housing location to another. Because this may only effect one student subscriber, there is no real demand for advertising space by third-party advertisers. However, if move day defines a day where all sophomores must move out of a particular dormitory to make room for the incoming freshman, then it may be judged and important event for selling advertisement space to local advertisers such as one whole provides moving boxes, or rents moving trailers, and so on.

In one embodiment advertisement engine 200 has a search utility provided thereto (not illustrated) and adapted to search all of time-based or calendar-based data periodically and to isolate time periods showing a high statistical commonality for a certain event or activity that may occur with respect to many subscribers, but according to a loose time table. By performing these types of searches periodically, the system may discover and define periods where advertisement space for certain products and services may be sold at a higher rate based on the findings. For example, if an entire month is given for students to evacuate the dormitories, the search utility may determine that 80% of the subscribers affected have actually scheduled their moves within the first two weeks of the month. Therefore related advertisement space is more valuable the first two weeks rather than the last weeks. In this way the system may optimize revenue earned from ad placement services and advertisers may optimize advertisement conversion rates using the targeting service.

One with skill in the art of HTML-based advertisement services will understand that in addition to content relevancy, placement of advertisements further targets time periods likely to produce better conversion rates. Further, geographic location is considered, in some cases, in solicitation of local advertisers so that they may be prepared to plan promotions and so on for upcoming events. Current systems do not take all of these factors into account dynamically. Moreover, the ability to search all subscriber-based calendar data enables discovery of otherwise missed opportunity in advertising.

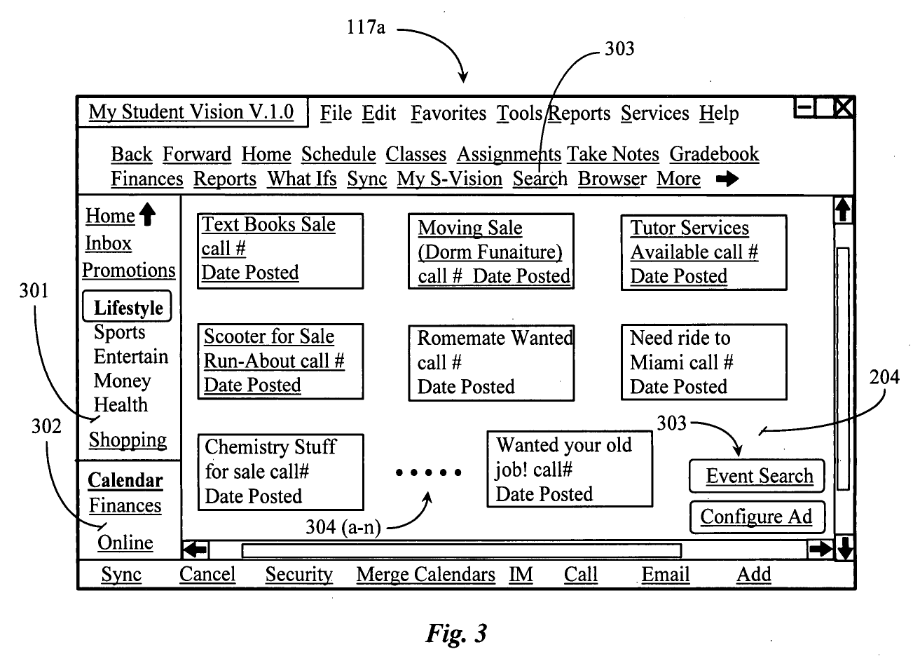

FIG. 3 is a plan view of student interface 117a of FIG. 1 illustrating dynamics of subscriber-sourced advertisement placement to other subscribers based on calendar-driven events according to another embodiment of the present invention. Interface 117a represents a student portal interface according to an embodiment known to the inventor. Interface 117a is in the form of a browser-capable interface supporting a plurality of user options for invoking services, data windows, processing functions, messaging applications, calendar information, class information, and so on. Sidebar areas 301 and 302 contain navigable options including lifestyle and calendar viewing options.

In this embodiment, interface 117a is displaying a student lifestyle page 204 invoked from sidebar 301 wherein a part of, most of, or the entire page is reserved for advertisement placement to the student, and wherein the advertisements are text-based advertisement sourced from other student subscribers and posted. Like the third-party advertisement placement embodiment described above, advertisements 304 (a-n) may be placed into lifestyle page 204 at such times when the calendar or other schedule-based information of the user indicates some statistical probability that the student may be more likely to cooperate with the goals of those advertisements. That is to say that instead of requiring the student to browse a local posting board containing many advertisements, the system may select certain ones of those posted advertisements and deliver them to certain interfaces based on current activities and schedule or calendar-based data intercepted from the interface and analyzed by the system.

For any given calendar period such as a Month, for example, the system of the present invention may intercept and analyze student-entered calendar data and university system calendar data that may be present. Depending on the perceived needs of the student based on the information gleaned, the system may browse advertisements on behalf of the student and place those advertisements into the student interface, perhaps in exchange for a slightly higher commission charged to the student advertisers than that usually paid for a simple advertisement posting to a public interface.

Advertisements 304 (a-n) include one for a text book sale, a moving sale, and one for tutoring services. Perhaps data analysis has shown that the student is scheduled to start a new class in a challenging subject and is moving to a new location. Hence the advertisements for textbooks, moving sale, and tutoring services are content relevant to what is happening in the user's life and the placement thereof at the specific time may be calculated to produce statistically higher conversion rates than normal for that placement. Likewise, the same advertisements may be placed in many other interfaces simultaneously and asynchronously if the data analyzed for those interfaces suggest a need for those products or services.

Perhaps calendar data suggests that a user's car is in the shop for 10 days for repair, hence the advertisement placement for a scooter for sale. A roommate wanted advertisement may be placed if there is a move-out scheduled or loss of dwelling is imminent. If calendar data suggests that the user is headed to Miami on a certain weekend, the advertisement for a person needing a ride to Miami may be presented. If the newly scheduled class described above is a chemistry class, then the advertisement for chemistry stuff for sale may be placed. If a calendar entry specifies a last day at a job, then the advertisement for wanted your old job might be placed. There are many possibilities. Student advertisers that may have their advertisements placed by the system based on system analyzed data, may not be charged for each placement, but may be charged a percentage of any conversion.

According to another embodiment of the present invention a search utility 303 is provided for a student advertiser to search calendar data of other students and of the general university or education system for the purpose of manually targeting those students in need of products or services with content relevant configured advertisements. In this embodiment, searching may be limited to those individuals that are willing to share their calendar data. An advantage of system data intercept, analysis, and advertisement placement is that no other student physically sees the actual data, which is not shared and is purged after use. Therefore, users are secure in the notion of privacy if they do not wish other students to have information about them.

The methods and apparatus of the present invention enable highly targeted HTML-based advertisement placement to a subscriber base for third-party advertisers and other subscriber-sourced advertisers whereby the targeting includes at least content relevancy and time sensitivity. In some cases geographic sensitivity is also included in advertisement placement. The example of a university or education client subscriber base is just one example of a possible audience for which advertisement placement may be practiced according to an embodiment of the present invention. Other classes of users that subscribe to a common portal service and for which calendar-based information is available to the system may be included as targeted audiences for advertising without departing from the spirit and scope of the present invention.

What is claimed is:

1. A system for placing advertisements in a user's display, comprising:
a portal through which the user communicates with content servers;
an advertisement engine operating coupled to the portal; and
a source of advertisements;
wherein the advertisement engine determines time and/or content-related information from the user's communication through the portal, selects advertisement from the source, and places the advertisements in display data directed to the user.

2. The system of claim 1 wherein the portal provides services related to the user's academic life and/or social life.

3. The system of claim 1 wherein the engine mines data at servers to which the user connects for time sensitive or content-related data.

4. The system of claim 1 wherein the selection of advertisements includes negotiating with an advertisement placement facility for pricing and placement duration.

5. The system of claim 2 wherein the user communicates with a server at an educational organization, and the engine determines time-sensitive information or content-specific information from the server, the information related to activities associated with multiple users.

6. The system of claim 5 wherein the engine selects and places advertisements commonly to the multiple users based on the time-sensitive or content specific information determined.

7. A method for placing advertisements in a user's display, comprising steps of:
(a) determining time-sensitive or content-specific information associated with at least one user from a portal through which the user communicates with content servers;
(b) selecting an advertisement from an advertisement source, the advertisement pertinent to the time-sensitive or content-specific information determined; and
(c) causing the advertisement selected to be placed in a display directed to the user.

8. The method of claim 7 wherein the portal provides services related to the user's academic life and/or social life.

9. The method of claim 7 wherein the engine mines data at servers to which the user connects for time sensitive or content-related data.

10. The method of claim 7 wherein the selection of advertisements includes negotiating with an advertisement placement facility for pricing and placement duration.

11. The method of claim 8 wherein the user communicates with a server at an educational organization, and the engine determines time-sensitive information or content-specific information from the server, the information related to activities associated with multiple users.

12. The method of claim 11 wherein the engine selects and places advertisements commonly to the multiple users based on the time-sensitive or content specific information determined.
